(19) United States
(12) Patent Application Publication
(10) Pub. No.: US 2010/0102943 A1
(43) Pub. Date: Apr. 29, 2010

(54) Wireless Touch Sensor

(75) Inventors: Mark Rutledge, Murrieta, CA (US); Minas Minassian, Vista, CA (US)

Correspondence Address: FISH & ASSOCIATES, PC;ROBERT D. FISH, 2603 Main Street, Suite 1000, Irvine, CA, 92614-6232, US

(73) Assignee: DEI HOLDINGS, INC., Vista, CA (US)

(21) Appl. No.: 12/260,364

(22) Filed: Oct. 29, 2008

(51) Int. Cl. B60R 25/00

(52) U.S. Cl. 340/426.36

(57) ABSTRACT

A passive keyless entry system is provided comprising a wireless touch sensor, a RFID tag, a security system, a sensor antenna connected to the security system that receives a sensor signal from the wireless touch sensor, and a tag antenna connected to the security system that receives a tag signal from the RFID tag. The security system unlocks a locking mechanism when both the sensor signal and the tag signal are received by the security system. Preferably, the RFID tag comprises an active RFID chip.

### FIELD OF THE INVENTION

The field of the invention is a keyless entry system.

### BACKGROUND

Keyless entry systems are known that utilize a key fob or other remote control to communicate with an automobile or other vehicle's security system, and unlock the vehicle's door. Actuation is typically by pushing a button on the remote. While using a remote is often more convenient than using a key, the user still requires a free hand to operate the remote. Thus, the remote, like a key, still requires an extra step by the user to unlock the door.

One solution that eliminates the extra step uses proximity detection systems. Such systems typically use a cell phone or other signal-emitting portable device, and are known to operate on many different frequencies and protocols, including for example UHF, Bluetooth, and radar. One problem with proximity detection is that the signal detection range can vary greatly from vehicle to vehicle, especially in aftermarket applications where vehicle dimensions and installations can vary greatly. Another problem is that known proximity detection systems tend to trigger a locking mechanism to unlock each time a user is within range of the detection system. Thus, in a poorly configured system, a car door might well unlock when the user is within the detection range, whether or not the user intended it.

Passive keyless entry systems have the advantage of eliminating the “extra step” altogether. For example, U.S. Patent App. no. 2006/0232378 to Ogino (pub. October 2006) teaches a piezoelectric sensor that cooperates with a keyless entry system to prevent unintended opening of the vehicle. That resolves some of the problems listed above, but requires extensive wiring, and therefore must typically be factory-installed. Among other things, such systems often require wiring to a powered, high frequency antenna as well as to a wired touch sensor at each entry point. These assemblies can require power and ground connections, as well as wiring to a main module to process the detected signals. Thus, the cost for the extensive wiring generally prohibits aftermarket installation.

Ogino and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Thus, there is still a need for a wireless touch sensor used with a passive keyless entry system that avoids the need for additional wiring and any extra steps by the user to unlock the door.

### SUMMARY OF THE INVENTION

In one aspect, the inventive subject matter provides apparatus, systems and methods in which a passive keyless entry system comprises a wireless touch sensor, a RFID tag, and one or more antennas.

Advantageously, the touch sensor is wirelessly connected to the keyless entry system. The wireless aspect can greatly reduce the time required and cost for installation on an after-market basis, since no external wiring is needed. Installation of the touch sensor only requires mounting it to any suitable surface including, which could, for example be a door, a door handle, a mirror, a hood, a gas tank door or a trunk lid.

All manners of radio frequency (RF) tags are contemplated as the RFID tag, including those using passive and/or active technologies. Active RFID chips are currently preferred because they tend to have a greater transmission range.

All antennas suitable to receiving a signal from the RFID tag and/or the touch sensor are contemplated. While multiple antennas can be used, a single antenna provides for quicker and less costly installation. Preferably, the installer will use an existing antenna of a security system, thereby eliminating the cost of installing a second antenna.

In preferred embodiments, the keyless entry system cooperates with an existing security system that acts to control a locking mechanism. For example, the keyless entry system might utilize the existing antenna and receiver of a security system, such that installation requires little more than reprogramming the security system to respond to signals from the passive keyless entry system. This can significantly reduce hardware and labor costs.

In an especially preferred embodiment, the passive keyless entry system comprises both an interrogator that rapidly interrogates an RFID tag, and a wireless touch sensor that wirelessly transmits a signal to a receiver. Once the signals of the RFID tag and the touch sensor are timely received, a locking mechanism unlocks the door. Timely receipt is contemplated to be within a one-minute period, and preferably within about 10 seconds; however, the period can be adjusted as needed to balance the competing needs of security and convenience.

Passive keyless entry systems according to the teachings herein can be used in fixed structures, including for example homes, offices, or other buildings, and can also be adapted to movable structures, including for example, cars, boats, trucks, and so forth. Conversion kits for existing structures, especially cars and trucks, are especially contemplated.

Various objects, features, aspects and advantages of the inventive subject matter will become more apparent from the following detailed description of preferred embodiments, along with the accompanying drawings in which like numerals represent like components.

### BRIEF DESCRIPTION OF THE DRAWING

FIG. 1 is a schematic of a passive keyless entry system for a vehicle.

FIG. 2 is a schematic of a passive keyless entry system for a building.

FIG. 3 is a flowchart for a method for facilitating unlocking of a door without a key.

FIG. 4 is a flowchart for a method of converting an enclosure to respond to a portable transmitter carried on a person.

### DETAILED DESCRIPTION OF THE DRAWING

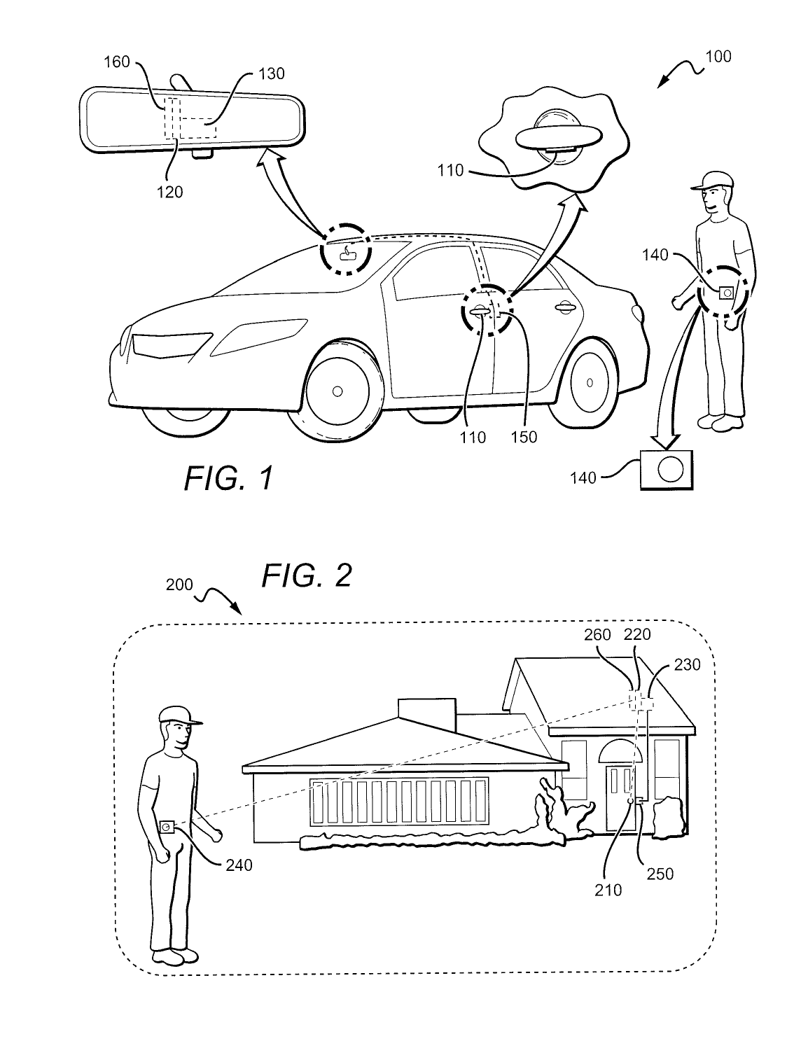

In FIG. 1 a passive keyless entry system 100 for a vehicle generally includes a wireless touch sensor 110, a RFID tag 140, a sensor antenna 120, a tag antenna 160, and a security system 130.

Wireless touch sensor 110 can be self-contained and lack external wiring. For example, wireless touch sensor might be sealed and disposable, but might instead have a user-serviceable battery (not shown). Wireless touch sensor 110 is preferably sized to be discretely mounted. For example, wireless touch sensor 110 could be sized to mount to an inside of a door handle on a vehicle. Thus, the wireless touch sensor 110 could be placed to be hidden from a passerby and not detract from the vehicle's appearance.

Wireless touch sensor 110 can comprise any sensor that wirelessly transmits a signal when actuated. Contemplated touch sensors include, for example a capacitive touch sensor, a fingerprint sensor and a push button sensor. Preferably, touch sensor 110 can be actuated and transmit a signal when a finger is pressed against the touch sensor. Because wireless touch sensor 110 lacks external wiring, the signal must be transmitted wirelessly, either directly or indirectly to sensor antenna 120. For example, wireless touch sensor can indirectly transmit a signal to a repeater (not shown) that transmits the signal to the sensor antenna 120.

RFID tag 140 can be radio frequency (RF) tag. Contemplated RFID tags 140 include passive or active RFID technologies. RFID tag functions by receiving an interrogation and transmitting a tag signal either directly or indirectly to the tag antenna 160.

In one aspect, RFID tag 140 is sized to be portable and user carried. Preferably, RFID tag 140 can be sized to fit inside of a wallet or a purse. More preferably, RFID tag 140 can be sized to be no greater in size than a standard business card (3.370 in×2.125 in). Most preferably, RFID tag 140 can be sized to fit inside of a cellular telephone or other similarly sized device. For example, a user can carry a cell phone embedded with RFID tag and unlock the doors by simply actuating the touch sensor 110. Thus, RFID tag 140 can be discretely carried and eliminate the need to carry additional items including keys and a keyfob or other remote.

Sensor antenna 120 can be any antenna capable of receiving a sensor signal from wireless touch sensor 110. Tag antenna 160 can be any antenna capable of receiving a tag signal from RFID tag 140. Both antennas can be functionally coupled to the security system 130 and thereby communicate the signals to the security system 130.

Preferably, sensor antenna and tag antenna can be a single antenna. More preferably, the passive keyless entry system 100 can utilize the vehicle's existing antenna (not shown) to function as sensor antenna 120 and tag antenna 160. Thus, the keyless entry system would require fewer components, which reduces the installation and overall system costs.

Security system 130 can be any suitable system that acts to control locking mechanism 150 and unlock a door when both the sensor signal and the tag signal are received. Preferably, security system 130 can be an existing security system of the vehicle.

FIG. 2 illustrates a passive keyless entry system 200 for a building comprising a wireless touch sensor 210, a RFID tag 240, a sensor antenna 220, a tag antenna 260, and a security system 230 that controls a locking mechanism 250. In other contemplated embodiments, the passive keyless entry system 200 can be used in any application having a similar access control requirement, including fixed structures, including for example homes, offices, or other buildings, and movable structures, including for example, cars, boats, trucks, and so forth.

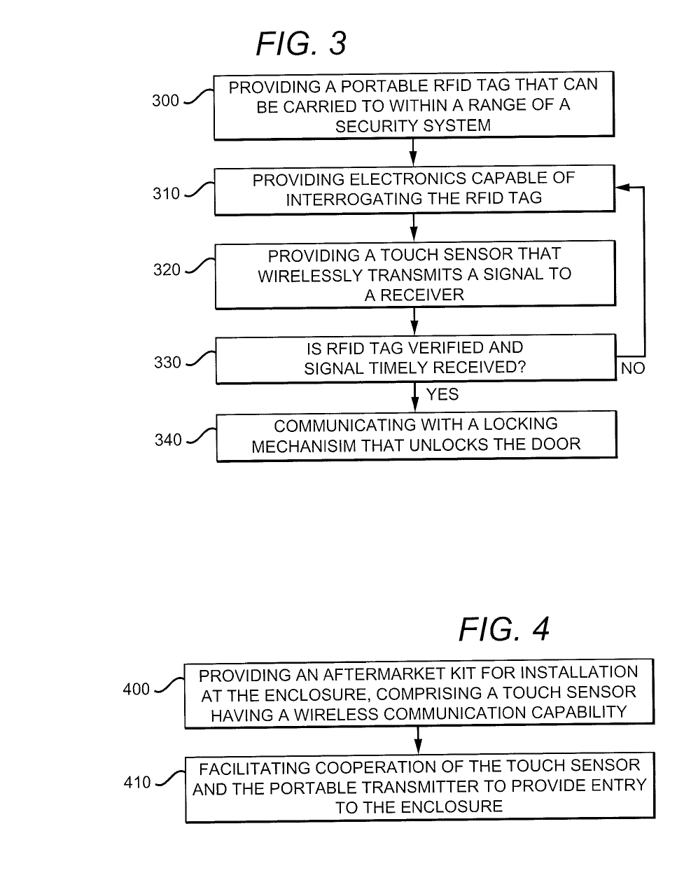

FIG. 3 depicts a method for facilitating unlocking of a door without requiring the insertion of a key. Initially, a portable RFID tag is provided that can be carried within a detection range of a security system 300. Preferably, the detection range of the security system is configured to be the transmission range of the RFID tag. Once the RFID tag is within the detection range, a provided interrogator can interrogate the RFID tag 310. Preferably, the interrogator interrogates the RFID tag at an intermittent interval of no more than ten seconds. In other contemplated embodiments, an interval between one and five seconds and a less than one second interval could be used. Unless a contrary intent is apparent from the context, all ranges recited herein are inclusive of their endpoints, and open-ended ranges should be interpreted to include only commercially practical values.

Electronics are provided that wirelessly transmits a signal from a touch sensor to a receiver 320. The security system then determines if the signal was timely received after the RFID tag signal has been verified 330. Timely receipt is preferably within one minute of receiving the tag signal from the RFID tag. If the signal is timely received, the security system instructs a door locking mechanism to unlock the door 340. If the signal is not timely received, the RFID tag is interrogated 310.

FIG. 4 depicts a method for converting an enclosure to respond to a portable transmitter carried on a person. Initially, an after-market kit is provided for installation at the enclosure 400. The kit can comprise a touch sensor having a wireless communication capability. Once installed, cooperation of the touch sensor and the portable transmitter can be facilitated to allow entry to the enclosure after close temporal activation of the touch sensor and the portable transmitter 410. Close temporal activation can be any reasonable period of time between the activation of the touch sensor and portable transmitter, and is preferably a period of less than 60 seconds, and more preferably between 10 and 20 seconds.

The touch sensor can preferably be installed at a door of the vehicle or other enclosure including, for example within a door or door handle, and on a door or door handle. Alternatively, the touch sensor can be installed on a surface of the vehicle.

In a preferred embodiment, cooperation can be facilitated by converting a pre-conversion security system to respond to signals received from the touch sensor and portable transmitter. The pre-conversion security system can be a security system of the enclosure that existed prior to the touch sensor's installation. Converting the system can be accomplished through hardware and/or software updates. Preferably, software of the pre-conversion security system can be updated to respond to the portable transmitter and touch sensor. In various embodiments, the pre-conversion security system can be utilized to unlock at least one of a driver door, a passenger door, a gas tank door, a trunk, and a hood.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A keyless entry system, comprising:
a wireless touch sensor;
a RFID tag that is physically separated from the wireless touch sensor;
a security system that controls a locking mechanism;
a sensor antenna functionally coupled to the security system, and receives a sensor signal from the wireless touch sensor;
a tag antenna connected to the security system that receives a tag signal from the RFID tag, wherein the security system acts to unlock the locking mechanism when both the sensor signal and the tag signal are received by the security system.

2. The keyless entry system of claim 1, wherein the security system acts to unlock the locking mechanism when the security system receives a start of the sensor signal within five seconds of receiving a start of the tag signal.

3. The keyless entry system of claim 1, wherein the security system acts to unlock the locking mechanism when the security system receives a start of the sensor signal within one second of receiving a start of the tag signal.

4. The keyless entry system of claim 1, wherein the security system acts to unlock the locking mechanism when receipt of the sensor signal overlaps at least partially with receipt of the tag signal.

5. The keyless entry system of claim 1, wherein the RFID tag uses passive RFID.

6. The keyless entry system of claim 1, wherein the RFID tag uses active RFID.

7. The keyless entry system of claim 1, wherein the wireless touch sensor is disposed on an automotive vehicle.

8. The keyless entry system of claim 1, wherein the wireless touch sensor is disposed on a building.

9. The keyless entry system of claim 1, wherein the wireless touch sensor is battery powered.

10. A method for facilitating unlocking of a door without requiring insertion of a key into a keyway, comprising:
providing a portable RFID tag that can be carried to within a wireless detection range of a security system;
providing an interrogator capable of interrogating the RFID tag;
providing electronics that includes a touch sensor and a transmitter that wirelessly transmits a signal to a receiver; and
communicating with a locking mechanism that unlocks the door upon verification of the RFID tag and timely receipt of the signal.

11. The method of claim 10, wherein the interrogator interrogates the RFID tag at an intermittent interval between one and five seconds, inclusive.

12. The method of claim 10, wherein the interrogator interrogates the RFID tag at an intermittent interval of less than one second.

13. The method of claim 10, wherein timely receipt is less than one minute.

14. A method of converting an enclosure to respond to a portable transmitter carried on a person, comprising:
providing an after-market kit for installation at the enclosure, the kit comprising electronics that includes a touch sensor and has a wireless communication capability; and
facilitating cooperation of the touch sensor and the portable transmitter, such that when the touch sensor is properly installed, close temporal activation of the touch sensor and the portable transmitter can be used to provide entry to the enclosure.

15. The method of claim 14, wherein the step of facilitating cooperation further comprises converting a pre-conversion security system of the enclosure to respond to signals received from both the touch sensor and the portable transmitter.

16. The method of claim 14, wherein the enclosure comprises an automotive vehicle.

17. The method of claim 16, wherein the step of facilitating cooperation comprises utilizing a pre-conversion security system of the enclosure to unlock at least one of a driver door, a passenger door, a gas tank door, a trunk, and a hood.

18. The method of claim 16, further comprising installing the touch sensor at a door of the vehicle.

19. The method of claim 16, further comprising installing the touch sensor on a surface of the vehicle.
